(19) United States
(12) Patent Application Publication
(10) Pub. No.: US 2010/0014141 A1
(43) Pub. Date: Jan. 21, 2010

(54) SCANNING DISPLAY APPARATUS USING LASER BEAM SOURCE

(75) Inventors: Anatoliy Lapchuk, Suwon-si (KR); Haeng-Seok Yang, Bucheon-si (KR); Seung-Do An, Suwon-si (KR); Victor Yurlov, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd., Suwon (KR)

(21) Appl. No.: 12/330,246

(22) Filed: Dec. 8, 2008

(30) Foreign Application Priority Data
Jul. 21, 2008 (KR) 10-2008-0070784

(51) Int. Cl. G02B 26/10

(52) U.S. Cl. 359/204.2

(57) ABSTRACT

Disclosed is a scanning display apparatus using a laser beam source. In accordance with an embodiment of the present invention, the scanning display apparatus can include a lighting optical system, configured to use a laser device as a light source, the laser device outputting a plurality of beams having different wavelengths that are recognized as an identical color; an optical modulator, configured to output a modulation beam by diffracting a beam transferred from the lighting optical system; a diffuser, placed on an optical path of the modulation beam outputted from the optical modulator and configured to expand a width of the modulation beam through a diffraction grating pattern formed on one surface of the diffuser; and a scanning mirror, configured to scan the modulation beam having passed through the diffuser on a screen.

### CROSS-REFERENCE TO RELATED APPLICATIONS

This application claims the benefit of Korean Patent Application No. 10-2008-0070784 filed with the Korean Intellectual Property Office on Jul. 21, 2008, the disclosure of which is incorporated herein by reference in its entirety.

### BACKGROUND

1. Technical Field

The present invention relates to a display apparatus, more specifically to a scanning display apparatus using a laser beam source.

2. Description of the Related Art

A human eye has a limited resolution. The human eye quantizes an object to a plurality of points according to human resolution in order to see the object. For example, when a certain object is placed at the distance of about 3 m in front of a human, an eye of the human recognizes the surface of the object as points having the diameter of 1 mm.

FIG. 1 shows how a human eye watches a diffuse surface. Referring to FIG. 1, if a laser beam 16 emitted from a laser light source is projected on a diffuse surface 14, an image corresponding to a point 18 of the diffuse surface 14 is focused on a retina of a human eye 12. The shapes on the diffuse surface 14, the sizes of which are smaller than the point 18 are unable to be resolved by the human eye 12. The point 18 includes a plurality of scattering centers, which scatters the laser beam 16.

The coherence of the laser beam 16 causes the scattering centers to create the coherence on the human eye 12. The interference enables the human eye 12 to recognize a certain point (e.g. the point 18) placed in the gray scale between the brightest point and the darkest point. Each scattering center of the point 18 becomes the centers of various light waves. Each light wave creates the conductive and/or destructive inference to determine a gray scale of the point 18.

For example, the point 18 becomes a bright point by the conductive inference of the light waves or a dark point by the destructive inference. This causes the human eye 12 to make particulate patterns on which bright, mid-bright and dark points are randomly patterned. The particulate pattern is referred to as a speckle.

Like the human eye 12 in FIG. 1, the same is also applied to a typical optical system. Accordingly, if the interference beam such as a laser beam is focused on a rough surface such as the diffuse surface 14, a speckle may be detected.

FIG. 2 is a picture including a granular pattern of bright, mid-bright and dark points. Since the speckle deteriorates the quality of a displayed image, the speckle is required to be suppressed.

### SUMMARY

Accordingly, the present invention provides a scanning display apparatus that can prevent the quality of an image displayed from being deteriorated by suppressing a speckle noise.

The present invention also provides a scanning display apparatus that can increase the contrast ratio of a displayed image by suppressing a speckle noise.

An aspect of present invention features a scanning display apparatus including a lighting optical system, configured to use a laser device as a light source, the laser device outputting a plurality of beams having different wavelengths that are recognized as an identical color; an optical modulator, configured to output a modulation beam by diffracting a beam transferred from the lighting optical system; a diffuser, placed on an optical path of the modulation beam outputted from the optical modulator and configured to expand a width of the modulation beam through a diffraction grating pattern formed on one surface of the diffuser; and a scanning mirror, configured to scan the modulation beam having passed through the diffuser on a screen.

Here, the diffraction grating pattern can be formed with a roughness of a Barker code sequence.

The laser device can be a laser diode array in which a plurality of laser diodes are arranged.

A wavelength shift between any two laser diodes of the laser diode array can satisfy a following formula,

Δλ≧λ₀²/4σ [Formula]

At this time, Δλ refers to a wavelength shift between output beams of any two of the plurality of laser diodes, λ₀ refers to a mean of wavelengths of each output beam outputted from the plurality of laser diodes, and σ refers to a root mean square of a surface roughness of the screen.

The laser diode array can be divided into two groups and is placed such that the two groups are orthogonal to each other, and a polarizer can be further placed in front of the laser diode array, and a beam outputted from the laser diode array can be differently polarized per group through the polarizer, to have a different polarization state.

The lighting optical system can include a red beam source, a green beam source, and a blue beam source as a color beam source, and the red beam source, the green beam source, and the blue beam source can be placed to be orthogonal to each other.

The scanning display apparatus can further include an objective lens for focusing on the modulation beam outputted from the optical modulator to the scanning mirror placed between the diffuser and the scanning mirror, and the diffuser can be configured to expand a width of the modulation beam such that a numerical aperture of a beam incident on the objective lens has a maximum value.

The diffuser can be adjacently placed in front of the optical modulator.

The scanning display apparatus can further include an objective lens for focusing on the modulation beam outputted from the optical modulator to the diffuser placed between the optical modulator and the diffuser.

The optical modulator can be a one-dimensional optical modulator, in which a plurality of micromirrors are arranged in a line in order to modulate an inputted linear beam, and the lighting optical system can further include a collimating lens, configured to collimating a beam outputted from the laser device; and a linear beam converting unit, configured to convert the collimated beam to the linear beam and transfer the linear beam to the optical modulator.

Here, the scanning display apparatus can further include a space filter, configured to allow a desired-order beam of the modulation beams outputted from the optical modulator to pass through it.

Another aspect of present invention features a scanning display apparatus including a light source unit, configured to use a laser device as a light source, the laser device outputting a plurality of beams having different wavelengths that are recognized as an identical color; an optical modulator, configured to output a modulation beam by diffracting a beam transferred from the light source unit; a diffuser, placed on an optical path between the light source unit and the optical modulator and configured to expand a width of an incident beam incident on the optical modulator through a diffraction grating pattern formed on one surface of the diffuser; and a scanning mirror, configured to receive the modulation beam outputted from the optical modulator and scan the received modulation beam on a screen.

Here, the diffraction grating pattern can be formed with a roughness of a Barker code sequence.

The laser device can be a laser diode array in which a plurality of laser diodes are arranged.

A wavelength shift between any two laser diodes of the laser diode array can satisfy a following formula,

Δλ≧λ₀²/4σ [Formula]

At this time, Δλ refers to a wavelength shift between output beams of any two of the plurality of laser diodes, λ₀ refers to a mean of wavelengths of each output beam outputted from the plurality of laser diodes, and σ refers to a root mean square of a surface roughness of the screen.

The laser diode array can be divided into two groups and is placed such that the two groups are orthogonal to each other, and a polarizer is further placed in front of the laser diode array, and a beam outputted from the laser diode array can be differently polarized per group through the polarizer, to have a different polarization state.

The lighting optical system can include a red beam source, a green beam source, and a blue beam source as a color beam source, and the red beam source, the green beam source, and the blue beam source can be placed to be orthogonal to each other.

The scanning display apparatus can further include an objective lens for focusing on the modulation beam outputted from the optical modulator to the diffuser placed between the optical modulator and the diffuser.

### BRIEF DESCRIPTION OF THE DRAWINGS

FIG. 1 shows how a human eye watches a diffuse surface;

FIG. 2 is a speckle picture including a granular pattern of bright, mid-bright and dark points;

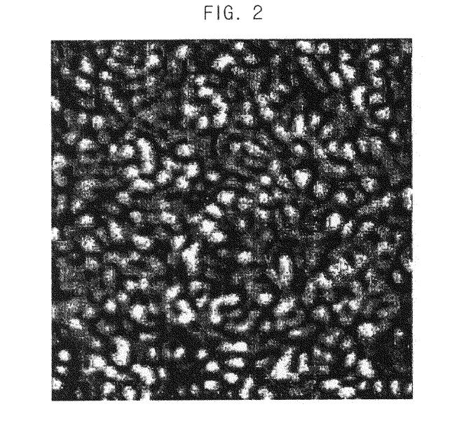

FIG. 3A shows a brief structure of a scanning display apparatus that uses a laser diode array as a light source, viewed from a side, according to the present invention;

FIG. 3B shows a projection part of the scanning display apparatus in FIG. 3A, viewed from another side;

FIG. 4 is a partial perspective view showing an optical modulator having a plurality of micromirrors according to the present invention;

FIG. 5 shows the structure of a lighting optical system in the scanning display apparatus in FIG. 3A;

FIG. 6 shows another laser diode array when a lighting optical system is formed according to the present invention;

FIG. 7 shows a brief structure of a scanning display apparatus in accordance with an embodiment of the present invention;

FIG. 8 shows a more-detailed structure of the scanning display apparatus in FIG. 7;

FIG. 9 shows how the width of a beam is expanded by a diffuser;

FIG. 10A shows an example showing a Barker code sequence as a diffraction grating pattern to be applied to a diffuser;

FIG. 10B shows a basic Barker code sequence having the length of 7;

FIG. 10C shows a compound Barker code sequence having the length of 7×7;

FIG. 10D is a graph showing a squared module of an autocorrelation function of a compound Barker code sequence having the length of 7×7;

FIG. 11 shows a brief structure of a scanning display apparatus in accordance with another embodiment of the present invention; and

FIG. 12 shows a brief structure of a scanning display apparatus in accordance with yet another embodiment of the present invention.

### DETAIL DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “inputted into” or “transferred to” another element, it shall be construed as being inputted into or transferred to another element directly but also as possibly having yet another element in between. On the other hand, if one element is described as being “directly inputted into” or “directly transferred to” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, some embodiments of the present invention will be described in detail with reference to the accompanying drawings.

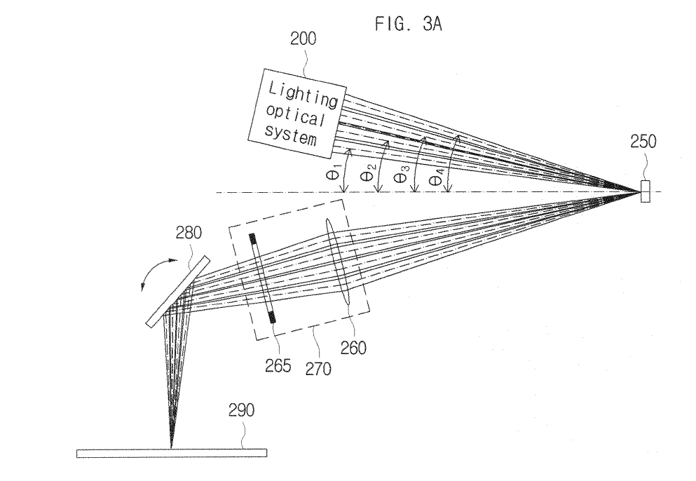

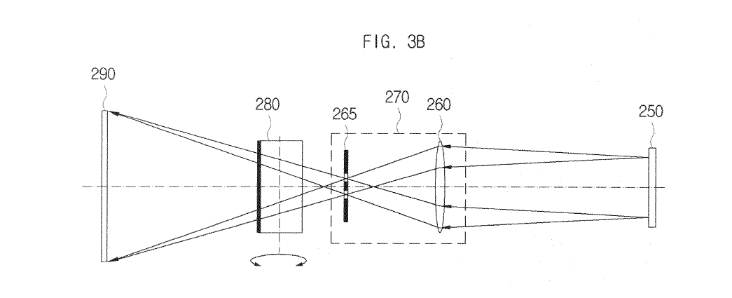

FIG. 3A shows a brief structure of a scanning display apparatus that uses a laser diode array as a light source, viewed from a side, according to the present invention.

As shown in FIG. 3A, the scanning display apparatus can roughly include a lighting optical system 200, an optical modulator 250, a projection optical system 270, and a scanning mirror 280. The scanning display apparatus can display a two-dimensional image on a screen 290 by scanning a one-dimensional linear beam to the screen 290 through the rotation of the scanning mirror 280.

Here, the lighting optical system 200 can include all optical elements which transfer a beam emitted from a light source to the optical modulator 250. In this description, the scanning optical system 200 further can include the light source. The projection optical system 270 can include all optical elements which transfer a beam (i.e. a modulation beam) outputted from the optical modulator to the scanning mirror 280.

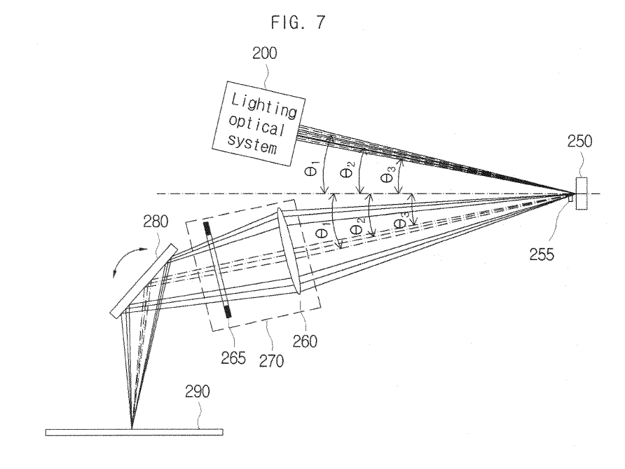

Hereinafter, configuration and function of each element will be described in detail with reference to FIG. 3B through FIG. 6 together. Of course, the same can be applied to the below description related to FIG. 7 through FIG. 12.

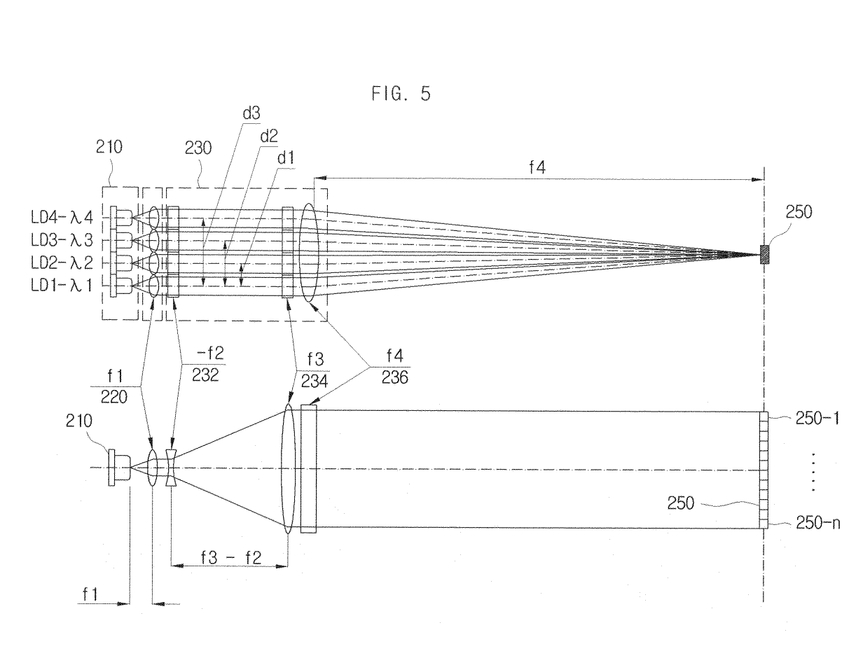

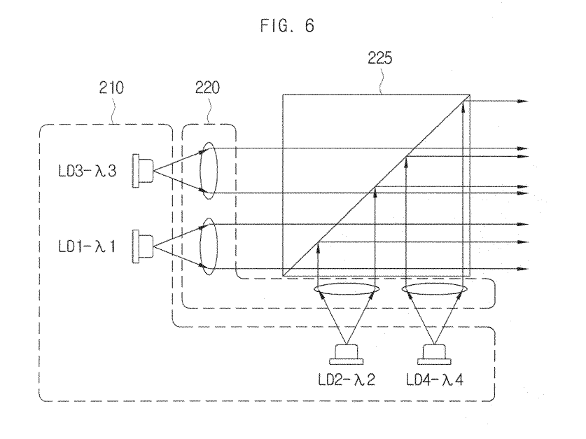

The lighting optical system 200 can include a plurality of lenses and optical parts, which perform the collimating, the adjustment of beam's paths, and the conversion to a linear beam, to allow a beam emitted from a light source to be accurately the optical modulator 250. The detailed configuration of the lighting optical system 200 and the functions of each element will be described with reference to FIG. 5 and FIG. 6.

The light source 210 can be a laser beam source that generates and emits a laser beam. This is because the present invention aims to suppress a laser speckle caused by the coherence of the laser beam. In accordance with each embodiment of the present invention, the laser beam source can employ a laser diode array in which a plurality of laser diodes are arranged in a certain form.

As shown in FIG. 5, the light source 210 can employ a laser diode array in which a total of 4 laser diodes LD1 through LD4 are arranged side by side. Here, the laser diodes LD1 through LD4 can emit each laser beam having different wavelengths λ1 through λ4. However, the beams having different wavelengths λ1 through λ4 may be recognized as the same color beams by human eyes.

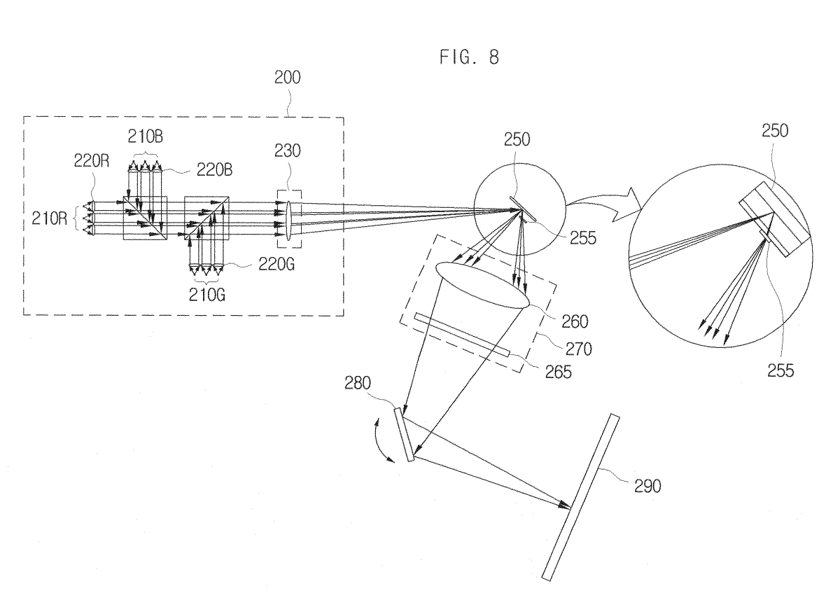

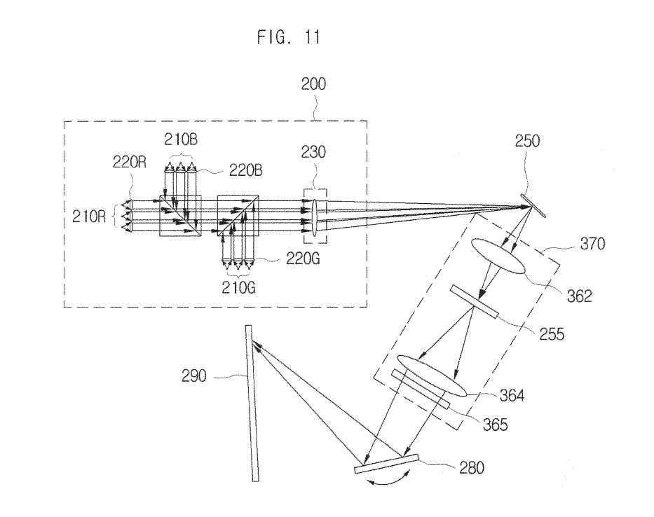

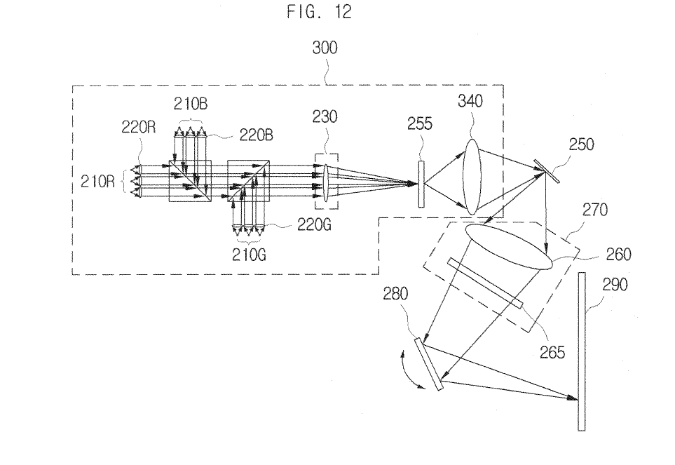

The light source 210 is merely conceptually shown in FIG. 5 as any one color light source for the convenience of illumination. In the case of employing red, green, and blue light sources, the lighting optical system 200 can be configured as shown in FIG. 8, FIG. 11, or FIG. 12.

When the light sources 210 are configured per color as in the present invention, it can be possible to suppress a speckle noise caused by the coherence of laser beams by using the laser diode array in which the plurality of laser diodes emitting laser beams, which have different wavelengths but are recognized as the same color beams by the human eyes. This is closely related to the principle of suppressing the speckle noise.

The speckle noise can be suppressed by overlapping a plurality of decorrelated speckle patterns. For example, if N decorrelated speckle patterns have the same average intensity, a speckle suppressing factor can be \sqrt{N}. If N decorrelated speckle patterns have different average intensities, the speckle suppressing factor can be smaller than \sqrt{N}. At this time, the decorrelated speckle patterns can be generated by time-divided overlapping or variation of frequencies or wavelengths as well as spatial overlapping.

Accordingly, in case that the plurality of laser diodes of the laser diode array are designed to emit beams having different wavelengths and each variation between the wavelengths creates decorrelated speckle patterns, the speckle noises can be suppressed in proportion to the square root of the number of the laser diodes.

According to the present invention, the wavelength shift between beams emitted from any two laser diodes, respectively, in the laser diode array can satisfy the following formula 1.

Δλ≧λ₀²/4σ [Formula 1]

Here, Δλ refers to the wavelength shift between beams emitted from any two laser diodes, respectively, of the plurality of laser diodes, and λ₀ refers to the average of wavelengths of beams emitted from the plurality of laser diodes. σ refers to the root mean square (RMS) value of the surface roughness of a screen.

In brief, when a beam emitted from any one laser diode has a wavelength λᵢ and a beam emitted from another laser diode has a wavelength λᵢ₊₁, if the wavelength shift (Δλ=λᵢ−λᵢ₊₁) between the two wavelengths λᵢ and λᵢ₊₁ satisfies the formula 1, it can be possible to generate a decorrelated speckle pattern.

Accordingly, if the wavelength shift between beams emitted from any two laser diodes, respectively, of the N laser diodes satisfies the formula 1, a total of N decorrelated speckle patterns can be generated. This can cause the speckle noises to be suppressed by \sqrt{N} times in the scanning display apparatus. The same speckle noise suppressing principle can be applied to each color light source in FIG. 8, FIG. 11, and FIG. 12, which is described below.

Although FIG. 5 shows the laser diode array has a configuration in which a plurality of laser diodes are arranged side by side, the laser diode array has another configuration. An example of another configuration is shown in FIG. 6.

As shown in FIG. 6, the plurality of laser diodes can be divided into two groups (i.e. one group has laser diodes LD1 and LD3, and the other group has laser diodes LD2 and LD4). The two groups can be placed orthogonally to each other. This means that the laser diodes LD1 through LD4 of two groups can be placed such that the direction of beams outputted from the laser diodes LD1 and LD3 is orthogonal to that of beams outputted from the laser diodes LD2 and LD4.

The laser diode array can further include, as shown in FIG. 6, a polarizer 225 in front. For example, the polarizer 225, as shown in FIG. 5, can be placed between a collimation lens 220 and a linear beam converting unit 230. Below described is the case of further including the polarizer 225 in front of the laser diode array.

As described above, the speckle noise can be suppressed in proportion to the square root of the number of decorrelated speckle patterns to be overlapped. Accordingly, more acquired decorrelated speckle patterns can cause the speckle noise to be significantly suppressed.

In constructing the laser diode array, however, it may be difficult to design to meet both conditions of: (1) the laser diode array being within a range of identifiable wavelengths as a same color beam, and (2) each wavelength shift between the laser diodes satisfying the above formula 1. It may be because it is possible to increase the number of the laser diodes to form the laser diode array only when both of the conditions are satisfied.

As described above, such difficulty can be overcome by placing the polarizer 225 in front of the laser diode array. As shown in FIG. 6, the polarizer 225 can be placed in front of the laser diode array that is divided into two groups. Accordingly, the beams outputted from the laser diode can be differently polarized per group through the polarizer 225, to have different polarization states. Here, that polarized beams outputted through the polarizer 225 have different polarization states indicates that the polarized beams mutually have orthogonality.

For example, P polarization and S polarization can mutually have orthogonality. The P polarization refers to a polarization that horizontally vibrates to the forwarding direction of a corresponding beam, and the S polarization refers to a polarization that vertically vibrates to the forwarding direction of a corresponding beam. As a result, that the P polarization and the S polarization mutually have orthogonality can indicate that the mutual coherence of the two polarizations may be significantly reduced. This may also mean that it is possible to acquire decorrelated patterns.

Accordingly, if it is assumed that a total of k decorrelated spackle patterns that can be acquired at the maximum through the two above conditions, when the polarizer 225 is additionally placed in front of the laser diode array as shown in FIG. 6, 2k decorrelated spackle patterns can be acquired at the minimum.

A liquid crystal polarization rotator or a half-wave plate can be used as the polarizer 225. Since the liquid crystal polarization rotator and the half-wave plate are the optical elements that can be easily recognized by any person of ordinary skill in the art, the pertinent detailed description will be omitted.

As shown in FIG. 5, the lighting optical system 200 can further include collimation lens 220 and the linear beam converting unit 230 that are placed in front of the foregoing light source 210. The collimation lens 220 can collimate a beam outputted from the light source 210. The linear beam converting unit 230 can receive the beam from the collimation lens 220 and convert the received beam into a one-dimensional linear beam.

As shown in FIG. 5, the linear beam converting unit 230 can include a total of three lenses 232, 234, and 236 (hereinafter, referred to as a first lens, a second lens, and a third lens). All of the first lens 232 through the third lens 236 can be cylinder lens.

For example, if it is assumed that an upper part of FIG. 5 shows an illumination part of the scanning display apparatus when viewed from the X-axis and a lower part of FIG. 5 shows the illumination part when viewed from the Y-axis, the first lens 232 can be a Y cylinder that allows the X-axis directional width of an input beam to be maintained as it is and the Y-axis directional width of the input beam to be expanded, and the third lens 236 can be an X cylinder lens that allows the Y-axis directional width of an input beam to be maintained as it is and X-axis directional width of the input beam to be condensed on a focusing point that is placed at a predetermined distance.

At this time, the second lens 234 can re-collimate the beam inputted from the first lens 232. It shall be evident to any person of ordinary skill in the art that the linear beam converting unit 230 can include optical elements (e.g. a divergent lens or a condenser) that is different from those of FIG. 5 to perform its functions.

As such, the linear beam converting unit 230 can condense the beams outputted from the light source 210 into one-dimensional linear beams in order to be incident on the optical modulator 250. Here, the method of determining the incidence angle of a beam passing through the linear beam converting unit 230 and being incident on the optical modulator 250 will be described with reference to FIG. 3A and FIG. 5.

For example, as shown in FIG. 5, it is assumed that the laser diode array in which a total of four laser diodes are arranged in a line is used as the light source 210, the focal distance of the third lens 236 is f4, the distance between a chief beam of an output beam outputted from the firstly ranged laser diode LD1 and a chief beam of an output beam outputted from the secondly ranged laser diode LD2 is d1, the distance between a chief beam of an output beam outputted from the firstly ranged laser diode LD1 and a chief beam of an output beam outputted from the thirdly ranged laser diode LD3 is d2, and the distance between a chief beam of an output beam outputted from the firstly ranged laser diode LD1 and a chief beam of an output beam outputted from the fourthly ranged laser diode LD4 is d3, the incidence angles θ₁, θ₂, θ₃, θ₄ of each incident beam can satisfy the following formula 2.

θ₂=θ₁+d1/f4; θ₃=θ₁+d2/f4; θ₄=θ₁+d3/f4; [Formula 2]

At this time, each of the incident beams can be transmitted to the optical modulator 250 without being overlapped. Alternatively, the incident beams may be partially overlapped with the adjacent incident beams before being transmitted to the optical modulator 250.

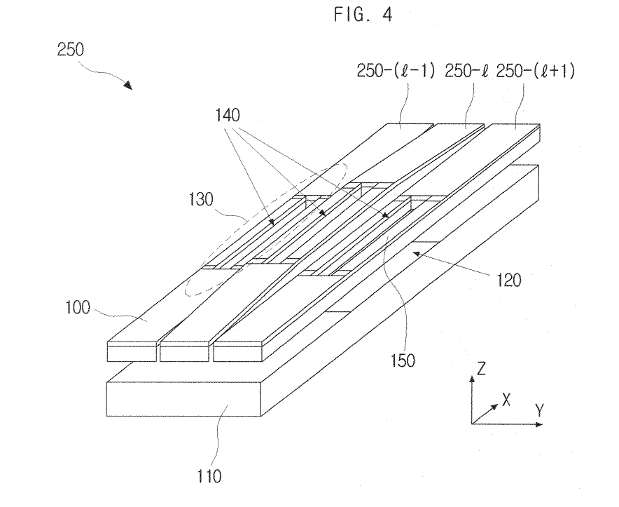

The reason that the aforementioned linear beam converting unit 230 in the lighting optical system 200 may be because the optical modulator 250 according to each embodiment of the present invention is a one-dimensional optical modulator in which a plurality of micromirrors are arranged in a line. Hereinafter, the one-dimensional optical modulator of the present invention will be described in detail with reference to FIG. 4.

In the optical modulator 250, a plurality of ribbons 250-1 to 250-n having each mirror layer are one-dimensionally arranged in a direction (e.g. a Y axis). Here, n is a natural number and equal to or greater than 2. The optical modulator 250 modulate an incident beam by moving each ribbon 250-1 to 250-n upwardly and downwardly (e.g. Z-axis direction) according to an electric signal of an optical modulator driving circuit (not shown). However, as described in FIG. 4, a (l−1)^{th} ribbon, a l^{th} ribbon, and a (l+1)^{th} ribbon 250-(l−1), 250-l, 250-(l+1) will be described Here, n is smaller than l.

The optical modulator 250 can include an insulation layer 110, placed on a substrate (not shown), a structure layer 100, having a center part 130 which is placed away from the insulation layer 110 at a predetermined distance, and a piezoelectric driving element (not shown), placed in both side parts of the structure layer 100 and allowing the center part 130 of the structure layer 100 to move upwardly and downwardly. The structure layer 100 can be formed with an upper mirror having a surface including the center part 130. Here, the surface can reflect a beam of light. The ribbon, which has a lengthwise shape in a direction, can include the structure layer 100 and an upper mirror 150.

If an open hole 140, as shown in FIG. 4, is formed in the center part 130 of the ribbon, only one ribbon can deal with one pixel in an image. If the open hole 140 is not formed, at least two ribbons can be grouped together to deal with one pixel.

Below described is the optical modulating principle in case that the open hole 140 is not formed.

The plurality of ribbons can move upwardly and downwardly according to a power (which is changed according to an electric signal of the optical modulator driving circuit) supplied to the piezoelectric driving element. For example, when the plurality of ribbons are maintaining a constant height, if a first power supplied to even-numbered ribbons allows the even-numbered ribbons to move upwardly or downwardly, the path difference may occur between a first reflection beam reflected from the even-numbered ribbons and a second reflection beam from the odd-numbered ribbons, to thereby create the diffraction (or interference). This may make it possible to modulate the intensity of beam, which can represent the gray scale of each pixel of an image.

Below described is the optical modulating principle in case that at least one open hole 140 is formed in the center part 130 of the ribbon.

At this time, a lower mirror 120, which reflects a beam, may be required to be formed on a surface of the insulation layer 110. Adjusting the power supplied to the piezoelectric driving element can allow the ribbon move upwardly or downwardly. This can adjust the distance between the upper mirror 150 formed on the surface of the ribbon and the lower mirror 120 of the insulation layer 110. The path difference may occur between a first reflection beam reflected from the upper mirror 150 and a second reflection beam reflected from the lower mirror 120, to thereby create the diffraction (or interference).

The gray scale of one pixel can be represented by using the path difference between each reflection beam of light in both cases of the ribbon having the open hole 140 and no open hole. By the diffraction (or interference) principle, each reflection beam can form diffraction beams of +1^{st} and −1^{st} diffraction orders D+1 and D−1 as well as a 0^{th}-order diffraction beam.

Below described is the case that in accordance with the present invention, a spatial filter 265 included in a below-described projection optical system 270 allows the 0^{th}-order diffraction beam to pass through it and the remaining order beams such as the +1^{st} and −1^{st}-order diffraction beams except for the 0^{th}-order diffraction beam not to pass through it. However, it shall be obvious that the opposite case of the spatial filter 265 not allowing the 0th-order diffraction beam to pass and allowing other beams to pass is possible. It can be also evident to any person of ordinary skill in the art that a driving device operated by an electrostatic method can be used in order to move the ribbon upwardly and downwardly, instead of the piezoelectric driving element.

The optical modulator 250 can modulate an incident beam and output a corresponding modulation beam in order to allow at least one or two ribbons to represent the gray scale of one pixel of an image. In other words, the optical modulator 250, as shown in FIG. 4 and FIG. 5, can allow a one-dimensional linear image to be represented by the plurality of ribbons 250-1 to 250-n that are one-dimensionally arranged in parallel with respect to a direction. At a point of time, the optical modulator 250 can represent a gray scale of any one (e.g. a vertical scanning line or a horizontal scanning device) of the one-dimensional linear image constituting a two-dimensional image.

The modulation beam, outputted from the optical modulator 250, corresponding to the one-dimensional linear image can be transferred to the scanning mirror 280 via the projection optical system 270. As shown in FIG. 3A and 3B, the projection optical system 270 can be constructed to include an objective lens 260 and the spatial filter 265. However, it shall be evident to any person of ordinary skill in the art that the projection optical system 270 can be constructed to include other optical elements.

The objective lens 260 can focus on a modulation beam outputted from the optical modulator 250 toward the scanning mirror 280. As described above, the spatial filter can allow a desired-order diffraction beam to pass through it among the modulation beams outputted from the optical modulator 250. Here, it may be unnecessary to include the spatial filter 265. If the spatial filter 265 is included, however, it can be possible to increase the resolution of a two-dimensional image to be displayed on the screen 290. At this time, the spatial filter 265 can be placed within a focal plane of the objective lens 260.

The scanning mirror 280 can scan the one-dimensional linear image transferred from the optical modulator 250 in one or two directions on a particular area of the screen 290 in order to display a corresponding two-dimensional image on the screen 290.

For example, when a two-dimensional image having the resolution of 640 horizontal pixels×480 vertical pixels is to be displayed on the screen 290, if the optical modulator 250 is a one-dimensional optical modulator that performs the optical modulation of the one-dimensional linear image corresponding to the 480 horizontal pixels, the scanning mirror 280 can horizontally scan the one-dimensional linear image by 640 times in order to display the two-dimensional image having the resolution of 640×480 on the screen 290.

It shall be evident to any person of ordinary skill in the art that the scanning mirror 280 can employ a galvano mirror, a rotating bar, or a polygon mirror scanner.

The same can be applied to the below description related to FIG. 7, FIG. 8, FIG. 11, and FIG. 12. Especially, the structure of the light source 210 can be identically applied to each embodiment of the present invention in FIG. 7, FIG. 8, FIG. 11, and FIG. 12. With the present invention, it can be possible to suppress speckle noises through roughly two principles.

In accordance with the first principle, as described above, when a laser diode array including a plurality of laser diodes is constructed as a light source for outputting a single color beam, it can be possible to suppress the speckle noises by designing the plurality of laser diodes that output beams having different wavelengths.

In accordance with the second principle, it can be possible to suppress the speckle noises by placing a diffuser such as a diffractive optical element. The first principle has been described above in detail. The second principle will be described below.

FIG. 7 is a sectional view showing an optical modulator module in which a phase control pattern is formed on a light transmissive substrate in accordance with an embodiment of the present invention.

As shown in FIG. 7 and FIG. 8, the scanning display apparatus in accordance with an embodiment of the present invention can include the lighting optical system 200, the optical modulator 250, a diffuser 255, the projection optical system 270, and the projection optical system 270, and the scanning mirror 280. Here, since the optical modulator 250, the projection optical system 270 and the scanning mirror 280 have been described above with reference to FIG. 3A through FIG. 4, the pertinent description will be omitted.

The lighting optical system 200 can be constructed by the same principle as described with reference to FIG. 3A, FIG. 3B, FIG. 5 and FIG. 6. However, in FIG. 8, since the lighting optical system 200, which is a color beam source, can separately include a red beam source 210R, a green beam source 210G, and a blue beam 210B, a dichroic mirror 228 can be further included in front of the color beam source, and collimation lenses 220R, 220G and 220B can be also included per color beam source.

Here, the dichroic mirror can be an optical element that is designed to allow output beams to pass through it or to be reflected according to the wavelength (i.e. color) of the output beams. If the dichroic mirror is included, it can be possible to the overall volume of the optical system to be compact. In particular, in FIG. 8, even through the red beam source 210R, the beam light source 210G, and the blue beam source 210B are placed to be orthogonal to each other, the dichroic mirror 228 can align the optical paths of each output beam without the significant increase of the volume of the optical system. The same can be applied to FIG. 11 and FIG. 12.

This embodiment of the present invention features the diffuser 255 that is adjacently placed in front of the optical modulator 250. This can be connected to the second principle that suppresses the speckle noises.

In this embodiment of the present invention, the diffuser 255 can be placed on the optical path of a modulation beam outputted from the optical modulator 250 in order to expand the width of the modulation beam. Herein, a diffraction grating pattern can be formed on one surface of the diffuser 255. The diffraction grating pattern formed on the surface can change the phrase of an input beam having passed through the diffuser 255, expand its width.

The diffuser 255 can employ an optical part, capable of displacing or adjusting the phrase of an input beam, such as a diffractive optical element. The diffraction grating pattern formed on one surface of the diffuser 255 can be formed by using the roughness of a Barker code sequence.

The Barker code sequence, which is a decorrelated sequence pattern having the length of 13 at the maximum, can be formed by the following formula 3. An example of the Barker code sequence is represented in the following example 1.

$$\begin{matrix}H ( x ) = {\sum }_{i = 0}^{N - 1} {B}_{i} \cdot rect ( \frac{N}{T} x - i ) & [ Formula 3 ] \\ B = [ \begin{matrix}1 & 1 & 1 & 1 & 1 & - 1 & - 1 & 1 & 1 & - 1 & 1 & - 1 & 1 \end{matrix} ] & [ Example 1 ]\end{matrix}$$

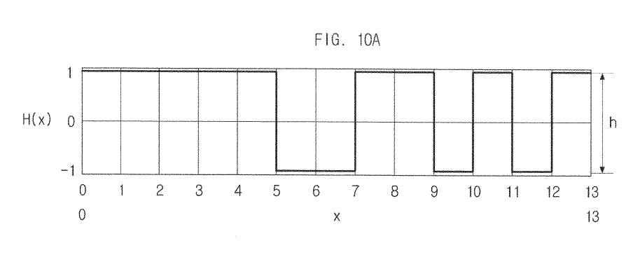

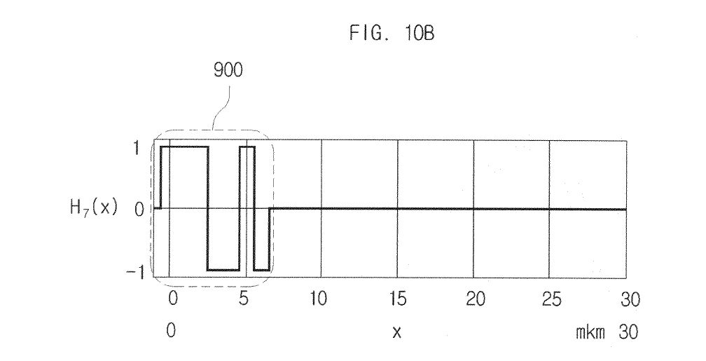

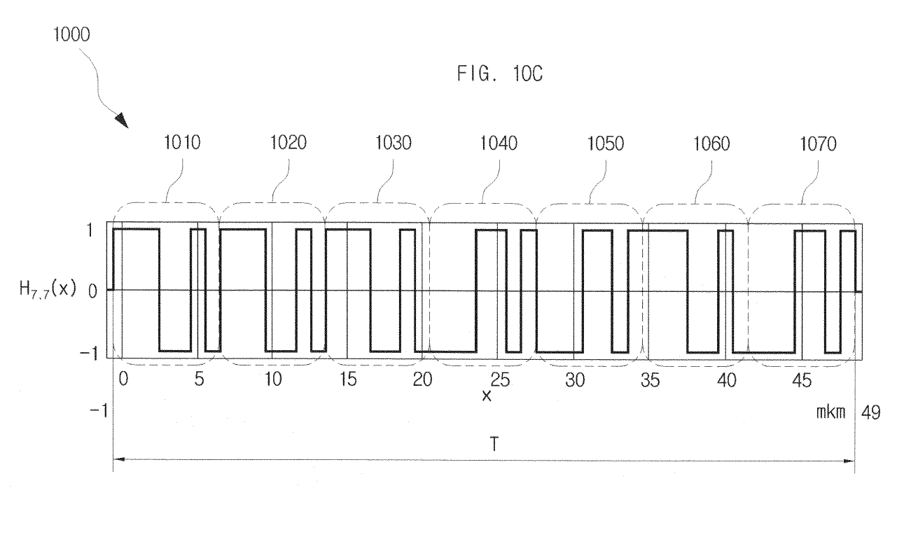

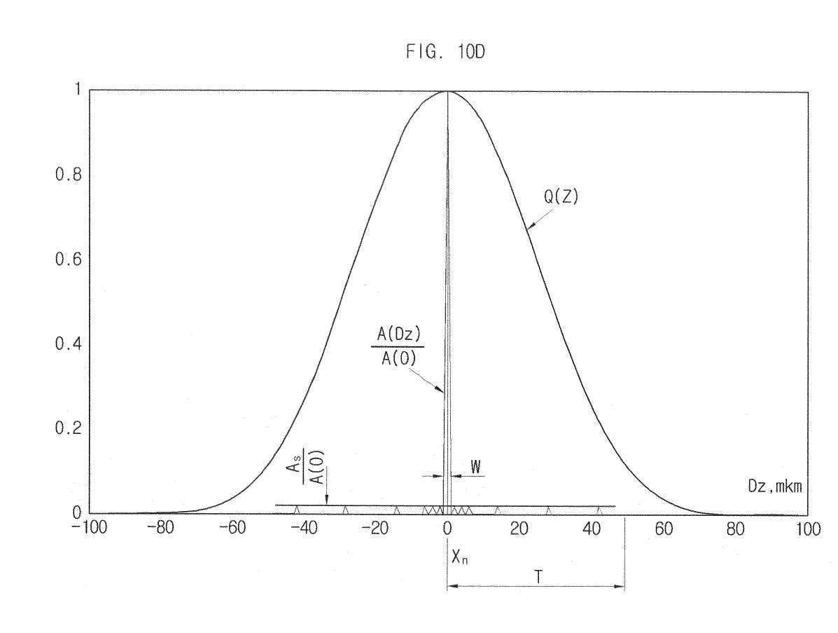

Here, rect (x−i) refers to a function having 1 in a section between i and i+1 and 0 in other sections. The Barker code sequence pattern according to the formula 3 and the example 1 is shown in FIG. 10A.

In the example 1, the positive (+) sign indicates a first relative phrase displacement, which is 0 radian, and the negative (−) sign indicates a second relative phrase displacement, which is π radian. Of course, it shall be evident to any person of ordinary skill in the art that the opposite case is also possible. The Barker code sequence pattern can be formed with the roughness that is embossed or engraved with two depths 0 and h. A beam incident on the Barker code sequence pattern can have the first relative displacement of 0 radian and the second relative displacement of π radian according to each depth, to thereby expand its beam width and be outputted to the space.

The pattern satisfying the formula 3 can feature its autocorrelation function having a narrow central peak (which is approximately identical to a single bit or a single pitch (T/N)) and a low side lobe level. This may indicate that a pattern is not correlated to a pattern that is shifted by Δx (Δx≧T/N) in the direction of X axis.

FIG. 10D is a graph showing a squared module of an autocorrelation function of a compound Barker code sequence having the length of 7×7. Here, as refers to maximum side lobe amplitude. A(0) refers to a central peak amplitude, w refers to a central peak width, and T refers to a total pattern width.

A(x) refers to an autocorrelation function of a phrase adjusting function H(x). Here, the squared module has a narrow central peak and a relatively low side lobe level. The autocorrelation function A(x) can be obtained by using the following formula 4.

A(x)=∫H(x−v)H*(v)dv [Formula 4]

Here, the phrase adjusting function H(x), which a normalized function, can be a Barker code in this embodiment of the present invention. Otherwise, a chirp signal and an M sequence can be used as the phrase adjusting function H(x).

At this time, the speckle contrast ratio can be represented as a function of Q(z) and A(Dz)/A(0). In the A(Dz)/A(0), the speckle contrast can be reduced by making the central peak narrower and decreasing the side lobe amplitude As. The autocorrelation function of the formula 4 can ideally approach to a Dirac-delta function, which is A(x)−δ(x). In this case, the speckle contrast may closely reach zero. This may indicate that it is possible to completely remove the speckle noises.

The autocorrelation function of the Barker code can have a very small side lobe level and a narrow central peak, thereby approaching to the Dirac-delta function. The more the Barker codes are, the more closely the autocorrelation function can approach to the Dirac-delta function.

Accordingly, if the Barker code sequence pattern as shown in FIG. 10A is used as the diffraction grating pattern, this can acquire the decorrelated speckle patterns corresponding to the length of the Barker code sequence pattern. The acquired decorrelated speckle patterns can be overlapped, to thereby suppress the speckle noises. In this example, since the Barker code sequence pattern has the length of 13, the decreasing factor can be \sqrt{13} at the maximum.

As already described, the length of the Barker code sequence pattern has a limitation, which is 13 at the minimum. In this case, it can be possible to use a compound barker code sequence, which is generated from the basic barker code according to the following formula 6.

$${H}_{n , m} ( x ) = {\sum }_{i} {H}_{n} ( x - i χ n ) {H}_{m} ( i χ m ) \qquad [ Formula 5 ]$$

Here, H_{n,m}(x) refers to a binary function indicating a new compound barker code sequence, and Hₙ(x) and Hₘ(x) refer to functions that define the basic barker code sequences having the lengths of n and m, respectively, and can be obtained by using the formula 6.

$${H}_{n} ( x ) = {\sum }_{i}^{n} {b}_{i}^{n} rect ( \frac{x - i χ}{χ} ) , \\ {H}_{m} ( x ) = {\sum }_{i}^{m} {b}_{i}^{m} rect ( \frac{x - i χ}{χ} ) \qquad [ Formula 6 ]$$

bᵢⁿ and bᵢ^{m} refer to structure elements, of the basic barker code sequence, having the lengths of n and m, respectively. In this case, the compound barker code sequence can have very long length M (M=n×m). The compounding method will be briefly with reference to FIG. 10B and FIG. 10C.

FIG. 10B shows a basic Barker code sequence having the length of 7, and FIG. 10C shows a compound Barker code sequence having the length of 7×7. In particular, FIG. 10B shows the basic barker code sequence H₇(x) 900 having the length of 7, of which the structure element vector is [1, 1, 1, −1, −1, 1, −1], and FIG. 10C shows the compound barker code sequence H_{7,7}(x) 1000 in which the basic barker code sequence 900 is compounded according to the formula 6. The compound barker code sequence 1000 includes 7 small barker code sequences 1100 through 1070, and each of the small barker code sequences is the same as the basic barker code sequence 900 or has the phrase that is opposite to that of the basic barker code sequence 900.

If the component of a structure element vector of the basic barker code sequence 900 is 1, the small barker code sequences 1010, 1020, 1030, and 1060 having the same phrases as that of the basic barker code sequence can be used to form the compound barker code sequence 1000. If the component of a structure element vector of the basic barker code sequence 900 is −1, the small barker code sequences 1040, 1050, and 1070 having the phrases opposite to that of the basic barker code sequence can be used to form the compound barker code sequence 1000. As a result, the compound barker code sequence 1000 can have the length of 7×7 (i.e. 49).

As described above, in accordance with an embodiment of the present invention, it can be possible as the second principle for suppressing speckle noises to use the method of placing the diffuser 255, having one surface formed with a diffraction grating of a particular pattern (e.g. the above-described barker code sequence pattern) for expanding the width of a modulation beam, on an optical path of the modulation beam. This can bring about the following effect in addition to the above-described first principle for suppressing the speckle noises.

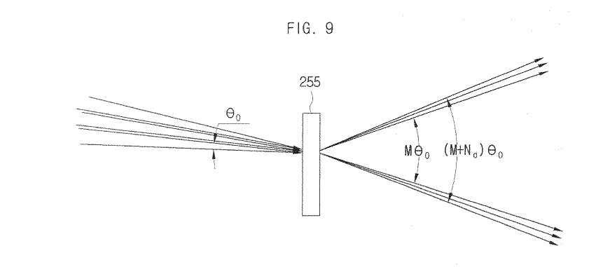

When the unit ratio of a beam width expanded by the diffuser 255 is M, M being a real number, if the light source 210 employs a laser diode array in which N_{d} laser diodes that output beams having the same wavelengths are arranged, the overall ratio of the beam width expanded by the diffuser 255 will be merely a value which is M+N_{d} as shown in FIG. 9.

Accordingly, the overall effect of suppressing the speckle noises can be in proportion to the square root of the value which is M+N_{d}. This may be because, in this case, it may be impossible to suppress the speckle noises according to the first principle, which uses a plurality of laser diodes outputting beams having different wavelengths, but it can be possible to use the effect of allowing the width of a beam to be expanded by the diffuser 255 in accordance with the second principle.

On the other hand, when the unit ratio of a beam width expanded by the diffuser 255 is M, M being a real number, if the light source 210 employs a laser diode array in which N_{d} laser diodes that output beams having different wavelengths are arranged, the overall effect of suppressing the speckle noises can be in proportion to the square root of the value which is M×N_{d}. This may be because the speckle noises can be suppressed in proportion to the square root of N_{d} in accordance with the first principle, and also the speckle noises can be suppressed in proportion to the square root of M in accordance with the second principle.

Accordingly, in order to suppress the speckle noises, if the aforementioned two principles are used together, it can be possible to expect the excellently outstanding effect of suppressing the speckle noises as compared with the case of using any one principle.

At this time, it can be considered as a good example that the diffuser 255 expands the width of a modulation beam such that the numerical aperture of a beam incident on the objective lens 260 has the maximum value. This may be because if the width of the modulation beam is expanded more widely, there may be optical loss.

Hereinafter, other embodiments of the present invention will be described. In the below-described embodiments, the aforementioned two principles for suppressing the speckle noises are identically used, but there is a little difference that the diffuser 255 is placed at a different area. Accordingly, the below-described embodiments will be described below based on a part of the optical structure that is different from the structure of FIG. 7 and FIG. 8.

FIG. 11 shows a brief structure of a scanning display apparatus in accordance with another embodiment of the present invention.

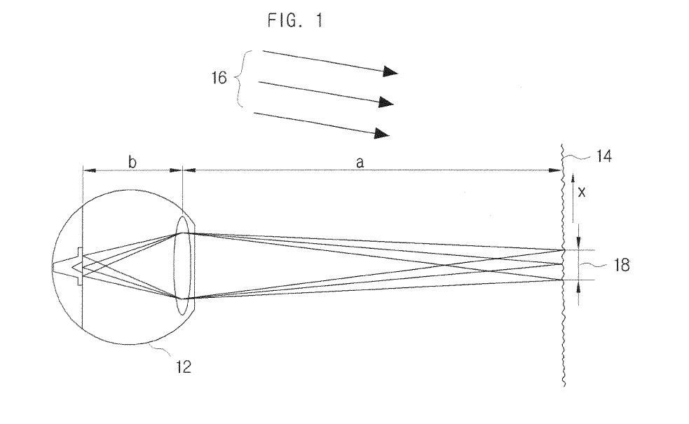

As shown in FIG. 1, the scanning display apparatus in accordance with another embodiment of the present invention can include the lighting optical system, the optical modulator 250, the diffuser 255, a projection optical system 370, and the scanning mirror 280. Here, the elements except for the projection optical system 370 can have the same functions and configurations as described above with reference to FIG. 7 and FIG. 8.

In accordance with another embodiment of the present invention, the projection optical system 370 can include objective lenses 362 and 364 placed between the optical modulator 250 and the diffuser 255, between the diffuser 255 and the spatial filter 265, respectively. This may be because the diffuser 255 is placed in an intermediate image plane of an optical path of a modulation beam, which is placed within the projection optical system 370 in accordance with another embodiment of the present invention.

Since the diffuser 255 in FIG. 7 and FIG. 8 is adjacently placed in front of the optical modulator 250, it may unnecessary to additionally place an objective lens (refer to the reference numeral 362 of FIG. 11). In the case of FIG. 11, however, since the diffuser 255 is placed away from the optical modulator 255, the objective lens 262 may be required to firstly condense on a modulation beam outputted from the optical modulator 250 and to transfer the collected modulation beam to the diffuser 255.

FIG. 12 shows a brief structure of a scanning display apparatus in accordance with yet another embodiment of the present invention.

As shown in FIG. 12, the scanning display apparatus in accordance with yet another embodiment of the present invention can include a lighting optical system 300, the optical modulator 250, the diffuser 255, the projection optical system 270 and the scanning mirror 280. Here, the elements except for the lighting optical system 300 can have the same functions and configurations as described above with reference to FIG. 7 and FIG. 8. There is a little difference that the diffuser 255 is placed after the linear beam converting unit 230 is placed.

In accordance with yet another embodiment of the present invention, the diffuser 255 can expand the width of a beam outputted from the light source 210 before the beam is incident on the optical modulator 250 by being placed in an illumination part of the lighting optical system 300. Accordingly, as shown in FIG. 12, a condensing lens 340 can be additionally placed between the diffuser 255 and the optical modulator 250. The condensing lens 340 can allow a beam having been outputted from the light source 210 and passed through the diffuser 255 to be converted to a one-dimensional linear beam before being incident on the optical modulator 250.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

1. A scanning display apparatus, comprising:
a lighting optical system, configured to use a laser device as a light source, the laser device outputting a plurality of beams having different wavelengths that are recognized as an identical color;
an optical modulator, configured to output a modulation beam by diffracting a beam transferred from the lighting optical system;
a diffuser, placed on an optical path of the modulation beam outputted from the optical modulator and configured to expand a width of the modulation beam through a diffraction grating pattern formed on one surface of the diffuser; and
a scanning mirror, configured to scan the modulation beam having passed through the diffuser on a screen.

2. The apparatus of claim 1, wherein the diffraction grating pattern is formed with a roughness of a Barker code sequence.

3. The apparatus of claim 1, wherein the laser device is a laser diode array in which a plurality of laser diodes are arranged.

4. The apparatus of claim 3, wherein a wavelength shift between any two laser diodes of the laser diode array satisfies a following formula,
Δλ≧λ₀²/4σ [Formula]
whereas Δλ refers to a wavelength shift between output beams of any two of the plurality of laser diodes, λ₀ refers to a mean of wavelengths of each output beam outputted from the plurality of laser diodes, and a refers to a root mean square of a surface roughness of the screen.

5. The apparatus of claim 3, wherein the laser diode array is divided into two groups and is placed such that the two groups are orthogonal to each other, and a polarizer is further placed in front of the laser diode array, and
a beam outputted from the laser diode array is differently polarized per group through the polarizer, to have a different polarization state.

6. The apparatus of claim 1, wherein the lighting optical system includes a red beam source, a green beam source, and a blue beam source as a color beam source, and
the red beam source, the green beam source, and the blue beam source are placed to be orthogonal to each other.

7. The apparatus of claim 1, further comprising: an objective lens for focusing on the modulation beam outputted from the optical modulator to the scanning mirror placed between the diffuser and the scanning mirror,
wherein the diffuser is configured to expand a width of the modulation beam such that a numerical aperture of a beam incident on the objective lens has a maximum value.

8. The apparatus of claim 7, wherein the diffuser is adjacently placed in front of the optical modulator.

9. The apparatus of claim 7, further comprising: an objective lens for focusing on the modulation beam outputted from the optical modulator to the diffuser placed between the optical modulator and the diffuser.

10. The apparatus of claim 1, wherein the optical modulator is a one-dimensional optical modulator, in which a plurality of micromirrors are arranged in a line in order to modulate an inputted linear beam, and
the lighting optical system further comprises
a collimating lens, configured to collimating a beam outputted from the laser device; and
a linear beam converting unit, configured to convert the collimated beam to the linear beam and transfer the linear beam to the optical modulator.

11. The apparatus of claim 1, further comprising a spatial filter, configured to allow a desired-order beam of the modulation beams outputted from the optical modulator to pass through it.

12. A scanning display apparatus, comprising:
a light source unit, configured to use a laser device as a light source, the laser device outputting a plurality of beams having different wavelengths that are recognized as an identical color;
an optical modulator, configured to output a modulation beam by diffracting a beam transferred from the light source unit;
a diffuser, placed on an optical path between the light source unit and the optical modulator and configured to expand a width of an incident beam incident on the optical modulator through a diffraction grating pattern formed on one surface of the diffuser; and
a scanning mirror, configured to receive the modulation beam outputted from the optical modulator and scan the received modulation beam on a screen.

13. The apparatus of claim 12, wherein the diffraction grating pattern is formed with a roughness of a Barker code sequence.

14. The apparatus of claim 12, wherein the laser device is a laser diode array in which a plurality of laser diodes are arranged.

15. The apparatus of claim 14, wherein a wavelength shift between any two laser diodes of the laser diode array satisfies a following formula,
Δλ≧λ₀²/4σ [Formula]
whereas Δλ refers to a wavelength shift between output beams of any two of the plurality of laser diodes, λ₀ refers to a mean of wavelengths of each output beam outputted from the plurality of laser diodes, and a refers to a root mean square of a surface roughness of the screen.

16. The apparatus of claim 14, wherein the laser diode array is divided into two groups and is placed such that the two groups are orthogonal to each other, and a polarizer is further placed in front of the laser diode array, and
a beam outputted from the laser diode array is differently polarized per group through the polarizer, to have a different polarization state.

17. The apparatus of claim 12, wherein the lighting optical system includes a red beam source, a green beam source, and a blue beam source as a color beam source, and
the red beam source, the green beam source, and the blue beam source are placed to be orthogonal to each other.

18. The apparatus of claim 12, further comprising: an objective lens for focusing on the modulation beam outputted from the optical modulator to the diffuser placed between the optical modulator and the diffuser.
